(19) United States
(12) Patent Application Publication
(10) Pub. No.: US 2013/0066789 A1
(43) Pub. Date: Mar. 14, 2013

(54) Project management tool

(71) Applicant: Peter John Ayrton Gaskell, Dubai (AE)

(72) Inventor: Peter John Ayrton Gaskell, Dubai (AE)

(73) Assignee: Gasconex Limited, Aberdeenshire (GB)

(21) Appl. No.: 13/529,394

(22) Filed: Jun. 21, 2012

Related U.S. Application Data
(63) Continuation of application No. 12/675,657, filed on Feb. 26, 2010, now abandoned.

(30) Foreign Application Priority Data
Aug. 31, 2007 (GB) 0716795.0

(51) Int. Cl. G06Q 10/06

(52) U.S. Cl. 705/301

(57) ABSTRACT

A project management system comprising a means for storing each of a plurality of process definitions, a plurality of phase definitions, a plurality of task definitions, an association between each task definition and a selected process definition and a selected phase definition, and task status information associated with each task, and a display means for displaying a two-dimensional grid arrangement in which a first dimension is subdivided according to process definitions and a second dimension is subdivided according to phase definitions, thereby to define a plurality of cells at the intersection of the two dimensions, a plurality of the cells thus defined therefore representing tasks, in respect of which task status information is displayed,a means for storing user identities and user rights associated with the user identities will allow the display means to be adapted to limit the display according to the user rights

This Application is a continuation of Ser. No. 12/675,657, filed Feb. 26, 2010, which is a Section 371 National Stage Application of International Application No. PCT/EP2008/002959, filed Sep. 1, 2008 and published as WO 2009/027709 A9 on Mar. 5, 2009, the content of which is hereby incorporated by reference in its entirety.

### FIELD OF THE INVENTION

The present invention relates to a project management tool.

### BACKGROUND ART

The current invention relates to the management of technical design projects. When a project is small, simple and fast, there is little need for specialized methods of project management. However, for larger more complex projects, that take place over longer periods of time, many issues arise, and the management of the project becomes critical to the success of the project.

In such projects, effective management is essential and will have a material effect on the final technical design. Poor management will produce a result that is late and/or over budget, but is also likely to produce a materially different design that is not optimal and/or not properly considered; effective management of the design process allows the engineers engaged in the project to give proper consideration to the available alternatives and can therefore produce a design that is better optimised to the task at hand.

Project management tools are well known. For example, the Gantt chart consists of a table of project task information, and a bar chart that graphically displays the project schedule depicting progress in relation to time. It is often used in planning and tracking a project; various software programs are available that implement the ideas behind the Gannt chart, such as “Microsoft project”.

Such 2 dimensional representations of the project do, however, have limitations. A large project, running across many departments, is still represented in an essentially a 2 dimensional format. This means that everyone involved in the project, at whatever level, and with whatever roles and responsibilities, sees the entire project structure. The relevant information for any individual within the project is embedded in a mass of irrelevant information, making it difficult for each individual to see the key relationships and within the project that lead to the successful completion of their part of the project.

These and other criticisms of the Gantt chart are described at the relevant Wikipedia entry at http://en.wikipedia.org/wiki/Gannt_Chart as of 28 Aug. 2007.

### SUMMARY OF THE INVENTION

Generally, traditional project management tools focus primarily on the ability to track a project (i.e. identifying when tasks can start, estimating task end dates, determining what the critical path is for the project, etc). Several issues exist in relation to this type of system, particularly:
1. Quality control is not enforced; tasks can be started/completed without quality control guidelines being adhered to, and with no tracking.
2. The project manager is required to track all tasks manually and then manually update the system.
3. A Gantt chart ‘only’ shows a real time estimation once the project manager has completed the update of each task's status estimation—typically on a weekly basis.
4. There is no audit trail to track issues/questions/discussions/etc for each task.
5. It is difficult for project managers to have a clear overview of how medium/large scale projects are performing, simply due to the number of tasks and their dependencies.
6. Team members working on a project may not have a clear understanding of where their assigned tasks fit in with regards to the entire project. Therefore they are not aware of the task dependencies and what the implications if their task is started/finished late.
7. With reference to project management software, team collaboration is not encouraged. Team members are not able to assess tasks and provide direct input into the master project plan.

This list is by no means comprehensive, but it does introduce some of the limitations that are present with current project management implementations.

Many projects now undertaken are of massive complexity, and improved project management tools are therefore needed. Examples of such projects are the design of a modern commercial airplane, where engineering, marketing and financial functions have to be effectively integrated at multiple levels from the directors in the board room, to the technicians on the shop floor. Another example is the design of complex subsurface oil wells, where equipment from multiple vendors has to fit together within the constraints of the oil well that has been drilled, and arrive on location at the correct time for assembly and installation in the well.

An innovation of the approach of the present invention is to not provide a generic tool to manage a project in a similar way in which traditional project management, but instead to identify a base system common to all industries and additionally provide an approach to tailor and effectively manage industry and company specific implementation standards and requirements. For instance the tool will seek to provide a means to generate a company/industry specific form (e.g. paper or electronic based file) to capture project task information which is linked to tasks, milestones and traffic lights it references. Comparing projects from different industries highlights compatibility issues with regards to how the system will incorporate the necessary functionality.

For example if you compare a software development project with an engineering project you will identify several tasks that differ substantially. By way of example, the design phase for a software development project requires the following tasks to be completed:
Requirements gathering/analysis
Context diagram (DFD)
Entity Relationship diagram (ER)
High Level Design
Low Level Design
Review Design

The design phase for an engineering project would require the following tasks:
Requirements gathering/analysis
Design object (3D CAD)
Create schematic diagrams/plans
Create Bill Of Materials
Review Design

It can be seen that the two project types differ substantially and the tools required for each industry are completely different. The above list of tasks is not comprehensive, but it illustrates how some tasks can be common to all types of project (i.e. requirements gathering, review design, etc). However the industry specific tools required for each type of project vary, therefore it is not feasible to create a system which will cater for any type of project.

The solution is to create a generic (abstract) system which can be extended to provide the tools for different types of project. Therefore the base system will define all the common tasks that are applicable to all types of project. Generally, the base tasks (i.e. those applicable to any type of project) will be marked as either mandatory or optional. If optional, this will mean that the user can elect not to include the task in their project plan.

Using the generic system it will be possible to extend the functionality and develop several versions of the software tailored for each industry. Therefore two different systems could be developed for the software and engineering industries based off the generic base system.

The current invention provides for a new project management tool that allows complex projects to be managed, controlled, and visualized in such a way that each person in the project sees precisely the information that they require, to operate most effectively within the project. So, in contrast to the static Gannt chart, the current invention provides for a dynamic display of information, that changes depending on who is viewing the information, as well as the status of the project.

A further aspect of the current invention is that the visualization of the project is multidimensional format. For example, at the highest level, the project may be viewed as a color coded square, the color depicting the overall status of the project. This may be an appropriate display for the Managing Director of a company. The project manager may also view the project in this way, but may also “drill down” into the square, that then becomes a 3-D cube, with many squares inside it. These internal squares may also be color coded, to illustrate their project status. The project manager could then “drill down” further into any one of these squares that then in turn become cubes containing more detail, to troubleshoot project problems.

It is important to note that at each “level”, the structure of the project visualization is similar, but the information changes, reflecting the different level, and depending on the viewer's roles and responsibilities.

The Project management system will seek to enable users to define alternatives for a project. The objective is to enable the user to create multiple alternatives and then compare them to identify the most applicable solution to implement. Typically the alternatives will be reviewed and a successful alternative selected.

The present invention therefore provides a project management system comprising a means for storing each of a plurality of process definitions, a plurality of phase definitions, a plurality of task definitions, an association between each task definition and a selected process definition and a selected phase definition, and task status information associated with each task, and a display means for displaying a two-dimensional grid arrangement in which a first dimension is subdivided according to process definitions and a second dimension is subdivided according to phase definitions, thereby to define a plurality of cells at the intersection of the two dimensions, a plurality of the cells thus defined therefore representing tasks, in respect of which task status information is displayed.

The project management system can further comprise a means for storing user identities and user rights associated with the user identities, the display means then being adapted to limit the display according to the user rights. The display of information can be limited by withholding information relating to processes and/or phases not defined in the user rights, and/or by aggregating a plurality of cells and displaying a composite task status.

This project management system is particularly (but not exclusively) useful in the design of an engineered item. The proper oversight of the project permitted by the invention allows a more optimal design to be arrived at, and can also improve the project timescale and budget.

The phase definitions and process definitions can be grouped into phase classes and process classes respectively, to create a higher level view at which potentially distracting detail is removed. This allows more senior management, who may have oversight of more than one project, to see the project status and identify which projects and/or parts of projects require attention. Accordingly, the display means is preferably able to display a two-dimensional grid arrangement in which a first dimension is subdivided according to process classes and a second dimension is subdivided according to phase classes, thereby to define a plurality of cell groups at the intersection of the two dimensions, a plurality of the cell groups thus defined therefore representing a plurality of tasks, in respect of which a composite task status information is displayed.

The display means can also show at least one status indicator associated with a cell, the status indicator showing one of a plurality of states, a subset of which indicate that passage to a subsequent phase is acceptable. The display means can further show a progress indicator, which is an aggregation of task status information and status indicators. This offers a combination of the two main development indicators that are of concern to those with oversight—is the work progressing, and is it being done with care?

This project management system is preferably provided via a suitable computer system, to which the present invention also relates. Accordingly, as well as providing such a computer system, the present invention further provides a software module arranged to implement when loaded onto a computer system a project management system as set out above.

In a further aspect, the present invention provides a project management summary view comprising a two-dimensional grid arrangement in which a first dimension is subdivided according to processes and a second dimension is subdivided according to phases of work, thereby to define a plurality of cells at the intersection of the two dimensions, a plurality of the cells representing tasks in respect of which task status information is displayed.

Thus, the project management tool allows both stakeholders and engineering functions to evaluate and identify accountability in a project. It provides a combination and synergy of metrics including but not limited to risk and quality assessment, project time management and budget constraint consideration.

Further, the project management tool allows decision making alternatives and their impact on the project to be audited in a format that can later be reviewed. Management decisions can be made with stakeholder consultation to compromise the project scope and design goals with respect to unforeseen circumstances, and to proceed through status indicators when necessary.

Unlike known systems, the present invention provides an inherited system rather than a generic project management tool; the approach is to identify a base system common to all industries and provide a flexible and extensible or scalable approach for the system to be tailored to and effectively manage industry and company specific implementation standards and requirements.

### BRIEF DESCRIPTION OF THE DRAWINGS

An embodiment of the present invention will now be described by way of example, with reference to the accompanying figures in which;

FIG. 1 is a grey scale colour mapping for the colours referred to in the present application and used in subsequent figures;

FIG. 2 shows the layout of a Project Map (Phases & Processes);

FIG. 3 shows additional detail in the Project Map in the form of Sub-Phases & Sub-Processes;

FIG. 4 illustrates a Task Definition;

FIG. 5 shows a typical development with time of Project Progress and Project Quality;

FIG. 6 shows the interrelationships in the steps involved as a Project progresses;

FIG. 7 shows a global view of a Project Plan;

FIG. 8 shows part of a Project Map for a Software Development project;

FIG. 9 shows a detailed view of part of FIG. 8 obtained by drilldown;

FIG. 10 shows part of a Project Map for the software engineering example, laid out using Project Phases;

FIG. 11 shows a further part of a Project Map for the software engineering example, laid out using Project Phases;

FIG. 12 shows a topmost level view of the Project Map;

FIG. 13 shows a Project Map for a Sub-Project;

FIG. 14 shows the addition of sub-processes to the Project Map;

FIG. 15 shows the addition of processes to the Project Map;

FIG. 16 shows duplicate processes in Sub-Project Map;

FIG. 17 shows a stack of multiple Sub-Projects;

FIG. 18 shows sub-project scenarios;

FIG. 19 shows a sub-project map with progress and quality indicators;

FIG. 20 shows a project map without progress indicators;

FIG. 21 shows a project map with progress and quality indicators;

FIG. 22 shows a roll-over linked milestone; and

FIG. 23 shows a project map using process phases for a construction example,

FIG. 24 shows an alternative representation of a process state selection.

### DETAILED DESCRIPTION OF THE EMBODIMENTS

Within this application, the following meanings have been used to describe project entity taxonomies.

| TERM | DESCRIPTION |
|---|---|
| Phase | A column on a Project Map. Define the |
| | deliverables that need to be produced. |
| Sub-Phase | A column on an Sub-Project Map |
| Process | A row on a Project Map. Define the activities |
| | that need to be performed to produce the |
| | deliverables defined by the Phases/Sub |
| | phases. |
| Sub-Process | A row on an Sub-Project Map |
| Master Cell | The intersection of an Process and a Phase on |
| | an Project Map |
| Cell | The intersection of a Sub-Process and a Sub- |
| | Phase on a Sub-Project Map |
| Project Map | The top level Project Map displaying all |
| | Processes for the given project, but not |
| | showing any Sub-Processes or Sub-Phases. |
| Sub-Project Map | A lower level Project Map displaying only the |
| | Processes which are the same type (i.e. with |
| | the same Sub-Phases). Also displays the Sub- |
| | Processes and Sub-Phases. |
| Scenario | An alternative for a specific Sub-Project |
| Unit | A collection of Tasks associated with a project |
| | deliverable (e.g. a sub-system in a software |
| | engineering project). |
| System Alternative | Each sub-project will enable one (or more) |
| | system alternatives to be defined. Each |
| | system alternative defines a different method |
| | of completing the sub-project. This could |
| | include: different designs, different suppliers, |
| | different resources, etc. |
| | System alternatives enable different solutions |
| | to be compared, reviewed and discussed. For |
| | any given sub-project there will always be a |
| | chosen alternative. |
| Placeholder | This is an abstract resource which acts as a |
| Resource | placeholder within the project plan. Sub- |
| | project/Project template by default contain |
| | placeholder resources. The project manager |
| | is responsible for replacing the placeholder |
| | resources with actual team member |
| | resources. |
| | NOTE: Placeholder resources are only |
| | applicable to ‘human resources’ (team |
| | members). |
| Un-assigned Task | Tasks added to the project (e.g. when adding |
| | a new Unit), which have not been associated |
| | with a Task on the Gantt chart. |
| Blocking Milestone | Milestones can have task (and milestone) |
| | dependencies associated with it. The |
| | dependencies enable the system to determine |
| | when a milestone has been successfully |
| | completed. |
| | A blocking milestone will physically check all |
| | dependencies to ensure all tasks have been |
| | fully completed. If a blocking milestone has |
| | incomplete tasks associated with it then the |
| | system will prevent users from starting any of |
| | the following tasks. However, users can |
| | override the system and start a task but they |
| | will have to provide a reason. |
| Informational | An informational milestone is not linked to any |
| Milestone | dependencies. These milestones are visual |
| | indicators used to inform users of key dates |
| | within the project plan. |
| Private Global Cell | This defines a cell within the top-level project |
| | map which is ‘not’ inherited by sub-projects. |
| | This type of cell is only applicable at the top |
| | level of the project map-therefore it is only |
| | defined once. |
| Public Global Cell | This type of cell is identical to ‘private global |
| | cells’ except it is visible to sub-projects. The |
| | project map defines one instance of the public |
| | global cell for the entire project. Sub-projects |
| | will inherit this cell and it will be visible within |
| | the project map when viewed. |

Each cell within the project map will be colour coded to indicate the status of the tasks contained within it. The colour coded statuses are summarised in the following table:

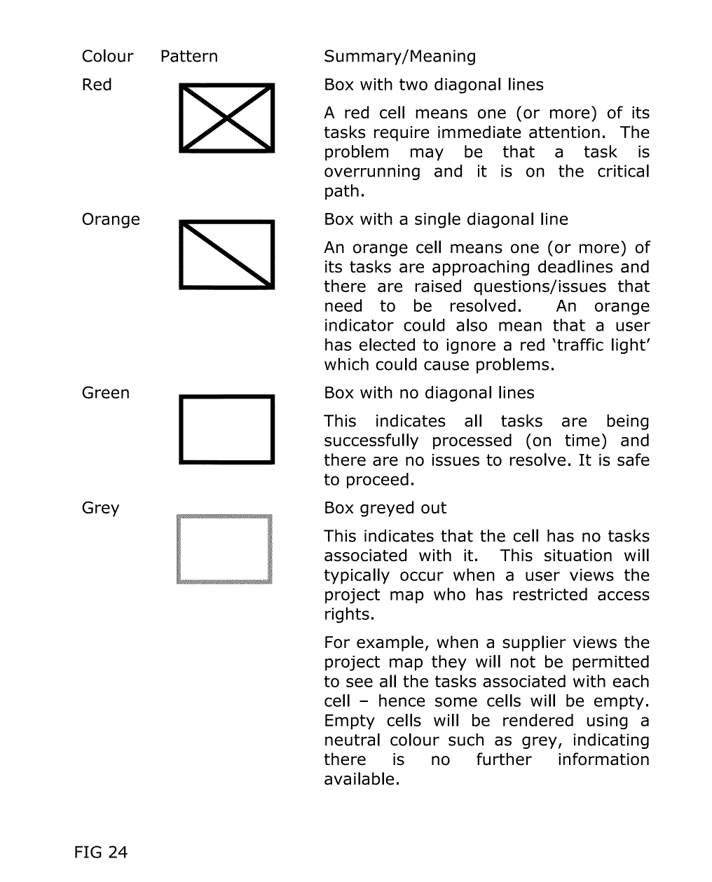

Some people are red-green colour blind, so the project management system will preferably not depend on colour media availability. Alternative representation of process state would be chosen depending on the situation to include but not be restricted to the use of grey scaling, or pattern representation e.g. crosses, diagonal lines FIG. 24.

The above table explains that if the traffic light is red then the user should resolve the critical issue. The user can elect to ignore this indicator however the system will make a note of this decision and they may be held accountable for this in the future if further problems arise.

Colour coding the cells within the project map will enable the project manager to assess the current status of their project plan. The graphical representation of a project plan will make it very easy for project managers to identify issues so they can resolve them immediately.

The colour of the traffic light indicator will be determined using either a paper based questionnaire or an electronic mechanism e.g. a script. Managers will have the ability to update the questionnaire/script to make it operate as they intend. For instance the crossing of a red traffic light may result in the invocation of a company procedure, or a requirement to notify higher management of the decision, or an automatic notification of higher management.

The effectiveness of any project management system requires both managers and engineers to enter accurate task status information. An exemplary implementation would have the following:
Quality /Accuracy of the data
Flexibility of data analysis
Providing data in an appropriate form
Accessible to a wide range of users and support a wide
Range of skills and knowledge
Improve interpersonal communications amongst management and employees
Allow individual project planning
Avoid information overload

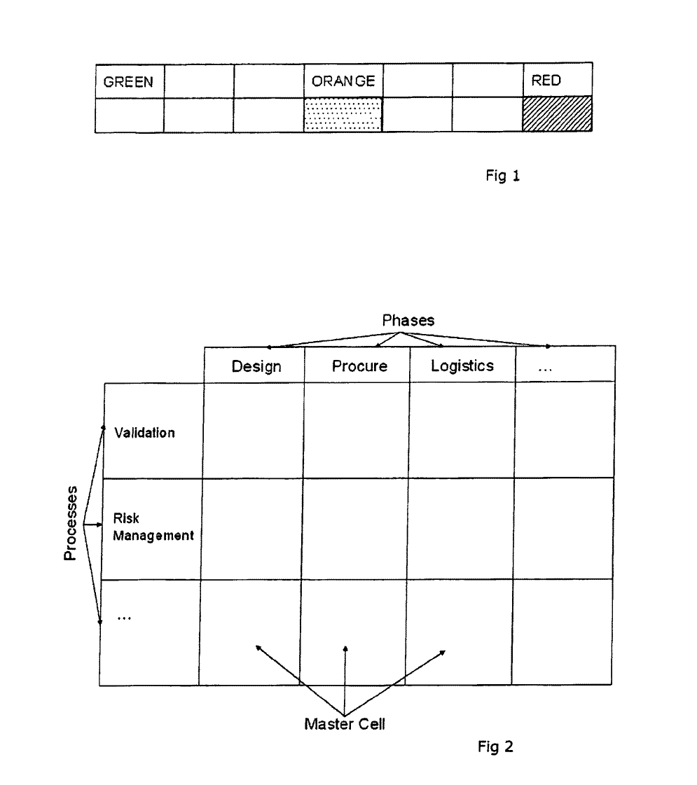

The project management tool diagrams that follow are representative and use grey scale mapping of the red-orange-green colour chart. FIG. 1 shows the colour gradient mapping chart from red to green mapped to grey scale equivalents. Wherever green is mentioned in the text a mapping should be applied accordingly.

It will be appreciated that there are many other ways of implementing the current invention, the following being examples to illustrate the key ideas and concepts.

The invention will enable all users to view the project using various existing and innovative tools. An overview of these tool sets is provided below:
1. Gantt-like Chart: This is the standard method of viewing the tasks that are associated with a project. The chart will include a new type of visual indicator called a ‘traffic light’. Traffic lights will indicate whether it is safe to proceed to the next task at strategic points in the project plan.
2. Project Map: The project map is an innovative way of viewing the project and its tasks. Each project is split up into phases and processes which create a grid. Each grid coordinate defines a cell. The cell defines an activity that needs to be performed. Each cell has one (or more) tasks associated with it—therefore when the user views a cell they can see the Gantt chart associated with it. At the top level the project map will colour code each cell to indicate its status (green=good, orange=potential problem, red=problem). The colour coding system will enable project managers to identify problems instantly. The project map will also show milestones and traffic lights associated with each cell.
3. Process Lanes Chart: The responsibilities associated with each phase/process can sometimes be unclear. The objective of the process lanes chart is to (a) identify all the core tasks associated with each phase of the project, and (b) to identify the responsibilities for each human resource assigned to manage each task. Therefore the system will define who is working on each task and what their role is. Roles include; Responsible, Consulted and Informed. Additional roles can be defined.

It is important to realise that the above tools will be made available to both project managers and project team members. This ensures everyone is aware of the current status of the project.

Granting all users access to the project plan means the system must provision the tools that are made available access the system. For example, the project manager should have access to all tools for managing the project, whereas an engineer should only be granted access to manage the tasks that they have been assigned. The system will achieve this provisioning by granting each user access rights. Each user will have a profile which defines who they are and what they are permitted to do.

Process and Phases Selection

The project map splits a project up into its phases and processes which create a grid. The phases of a project might include; design, build, implementation, testing. Each of these phases would have processes associated with them. For example the design phase would have the following processes; Validation, Risk Assessment, Review, etc. The intersection of a phase and a process is referred to as a ‘Master Cell’ (FIG. 2). Each master cell has attributes associated with it (including one or more tasks) which are inherited by all tasks contained within it.

Each phase may consist of one (or more) sub-phases, whereas equally a process may consist of one or more sub-processes.

The Phases/Sub-Phases within a project defines the deliverables that need to be produced. The deliverables define the outputs for each phase as shown in FIG. 2.

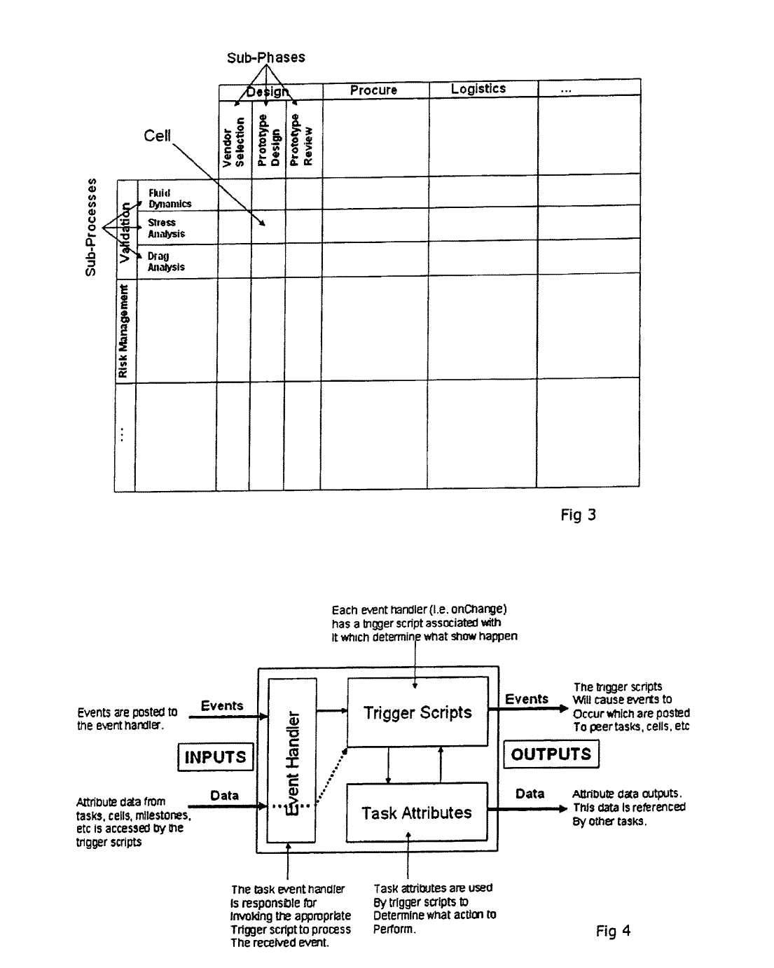

The Processes/Sub-Processes within a project define the activities that need to be performed to produce the deliverables defined by Phases/Sub-phases, as shown in FIG. 3.

A cell is the intersection of a sub-phase and a sub-process, and defines an activity which needs to be performed. Contained within each cell is a list of tasks which are linked together to form a process. Therefore it is possible to consider the cell as, in effect, a mini Gantt chart. A Cell inherits all of the attributes from the parent Master Cell it is associated with. A Cell will also define its own set of attributes which will be accessible to tasks contained within it.

In order for projects to be managed, controlled, and visualized it is important to clearly define how the Phases and Processes are chosen. The way these elements are selected affects the design of the Project Map because it can change how the Project map will be displayed, and how it functions. The aim is to get an even spread of active cells.

Tasks and Events

A task defines an activity that needs to be performed to produce an output. A series of tasks define a process where the end product is a deliverable or service. A task has the following attributes, illustrated in FIG. 4:

TABLE 1
Tasks and Events

| Attribute | Description |
|---|---|
| Inputs | The inputs for a task define its dependencies. The |
| (dependencies) | inputs are used by the task's trigger script to |
| | determine (a) when the task can start, and (b) |
| | when the task has been successfully completed. |
| | A task input can be: |
| | Global attribute |
| | Task attribute |
| | Cell attribute |
| | Human Resource attribute |
| | Non-Human Resource attribute |
| | Milestone attribute |
| | Traffic Light attribute |
| | The above objects all have attributes associated |
| | with them. These attributes can all be used as |
| | inputs into the task. |
| | For example: an input could be that ‘task1’ has to |
| | be complete-therefore ‘task2’ could check the |
| | ‘task1->status’ attribute to determine if it has been |
| | completed. If task1 is not complete then the ‘start |
| | trigger script’ will not permit the task to proceed. |
| | NOTE: The task inputs are defined by the trigger |
| | scripts. If a script references an attribute |
| | associated with an external object then it is an |
| | input. |
| Events | Each task has events associated with it. Task |
| | events are triggered by the project management |
| | system when changes occur. For example when a |
| | user updates a task's status the project |
| | management system needs to inform all dependant |
| | tasks of the update. This is achieved by generating |
| | a ‘change’ event and posting it to all dependant |
| | tasks. |
| | NOTE: Dependant tasks needs to be notified |
| | because they ‘may’ be affected by the change that |
| | occurred and may have to perform some special |
| | processing. |
| | The events associated with a task are as follows: |
| | Update: Invoked when the system |
| | identifies a change that may affect the task- |
| | hence it is updated. |
| | Complete: Invoked when the user sets |
| | the task status to complete (100%). This |
| | enables the system to perform some post |
| | processing-i.e. to determine whether the |
| | task was successfully completed. |
| | Change: This occurs when the user |
| | updates the task (i.e. sets the status). |
| | The above list is not comprehensive but it does list |
| | some of the core task events that can be handled. |
| Trigger Scripts | Each task event can ‘optionally’ have a trigger |
| (Conditions) | script associated with it. The script defines what |
| | should be done when the event occurs. For |
| | example when a Complete event occurs the task |
| | may want to perform some checks to determine |
| | whether any special processing should occur-i.e. |
| | the system could display a dynamic form asking |
| | the user to input additional information about the |
| | completion of the task (perhaps a conclusion). |
| | The script associated with the Update event will |
| | typically be used to determine whether the task |
| | can be started. The Update script will check |
| | various dependencies (tasks, cell, milestones, |
| | traffic lights, etc) to determine whether it is ok to |
| | start the task. If the dependencies are all |
| | successful then the task can be started. |
| | NOTE: It will not be possible for a task to update |
| | an attribute associated with another object (i.e. |
| | task, cell, etc). Each object is responsible for |
| | updating its own resources when an event occurs. |
| | If this feature was provided it could easily produce |
| | unexpected results and add unneeded confusion to |
| | the project management system. |
| | Tools will be provided which enable users to define |
| | trigger scripts using a graphical aid (therefore no |
| | programming knowledge will be required). |
| | However users will also have the ability to edit the |
| | trigger script manually if required. |
| Attributes | Each task has attributes associated with it. The |
| | attributes are used by the project management |
| | system to process the associated task |
| | appropriately. |
| | Attributes can be read by external objects. |
| | However external objects can not update/set an |
| | attribute associated with a task. All task attributes |
| | are ‘read only’. |
| Outputs | Each task can generate outputs. Task outputs to |
| | several forms including: |
| | Generating an event |
| | Setting the value of an attribute |
| | The ‘event’ outputs will cause the project |
| | management system to notify all affected |
| | (dependant) objects of the change. Whereas the |
| | attribute |
| | Task outputs can be generated by the trigger |
| | scripts when an event occurs. Alternatively |
| | outputs can be generated by the project |
| | management system. |

When a task receives an event the event handler will cause the appropriate trigger script to be invoked. There is a one to one relationship between events and trigger scripts. If a trigger script has been defined then it has the ability to reference data attributes from external objects (including: tasks, cells, milestones, traffic lights, dynamic forms and global attributes). The trigger script can then determine what actions need to be performed based on this information.

A traffic light is implemented using trigger scripts. Each time a task is updated the traffic lights within a Gantt chart or project map are revaluated to determine if their state has changed. The colour of a traffic light is determined by the trigger script associated with it. The traffic light sequence approach will enables users to generate the trigger scripts. This will enable any of the aforementioned dependencies to be referenced. Provided below is a traffic light script which could be implemented by an electronic script:

```
Refresh( )
{
  variable count = 0;
  IF ( task1.status = COMPLETE )
  Count+1;
  IF ( cell.status = COMPLETE )
  Count+1;
  IF( milestone.status = COMPLETE )
  Count +1;
  IF( resource.status != AVAILABLE )
  Count=0;
  IF ( count <= 1 )
  Traffic_light.state = RED;
  ELSE IF ( count = 2 )
  Traffic_light.state = ORANGE;
  ELSE IF ( count = 3 )
  Traffic_light.state = GREEN;
}
Quality Graph
```

The project map and Gantt chart tools utilise traffic lights to determine the status of a process. Each traffic light is programmed to measure various characteristics of the project to determine its status (red, orange or green).

Each project will contain a known number of traffic lights. Each traffic light has three states (green=good, orange=potential problem, red=problem). Each traffic light state will be assigned a score value (green=0, orange=−1, red=−2). The system can use this information at any time to generate a quality score rating for the project, sub-project, master cell, or process.

The system will also provide a tool which enables the progress graph to be overlaid on top of the quality graph. This graph will provide a useful insight into the running of the project and can be used to identify sections of the project where issues were introduced. FIG. 5 is a graphical illustration of how this graph might look.

### EXAMPLE

### Example 1

### Software Development Life Cycle

A company wishes to design and implement a ‘Killer’ Application. There are many design models for representation of the various process phases involved which require project management. Most of these approaches to process mapping are based or evolved from the traditional Waterfall view and the phases are essentially as follows (Note-variations may be found in the literature which in effect sub-divide or aggregate the phases listed here):

1) Requirement Analysis

2) Design

3) Implementation

4) Verification

5) Review and Maintenance

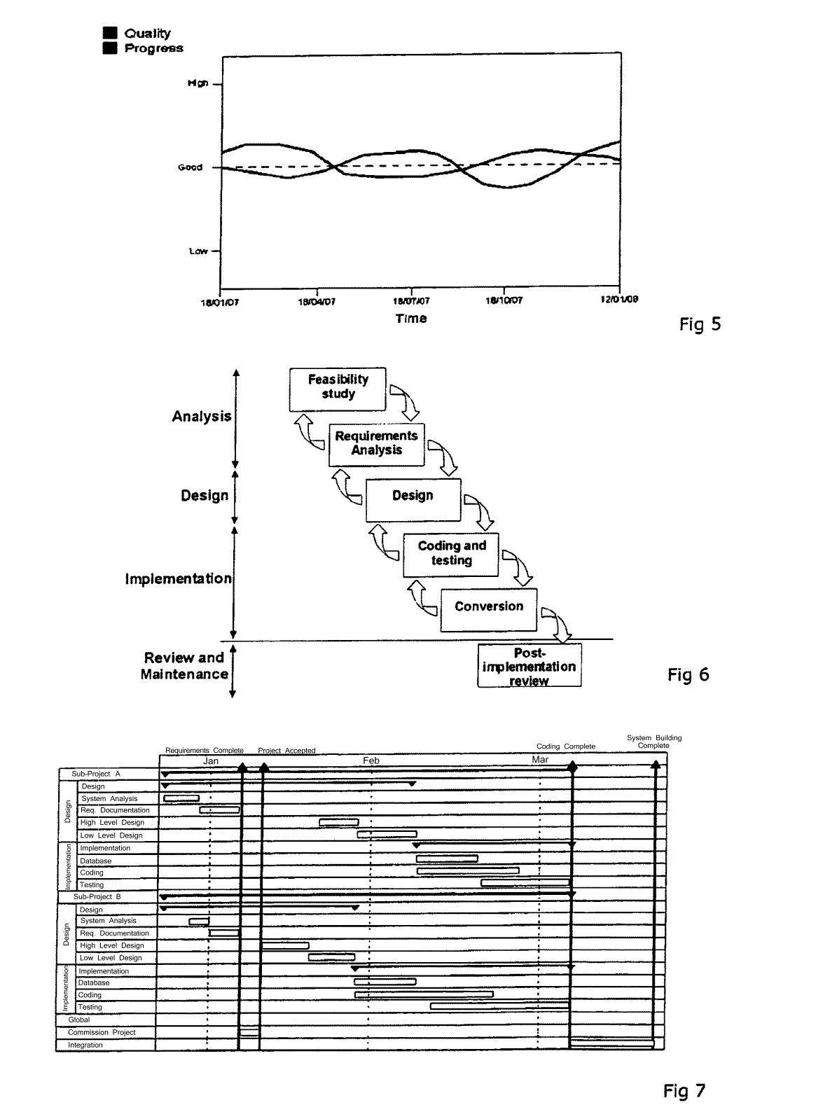

Theses are illustrated schematically in FIG. 6.

This approach is a design method and its adoption has been superseded by more iterative approaches to complete lifecycle process. An example from IBM deriving from the Rational Software Company (www.rational.com) provides guidelines, templates and tools. It covers requirements, design, testing, project management and configuration management so allows all team members to maintain a common view of the software. The project is broken down into four phases which map to the phases of the waterfall design.
Inception (deciding what to build)
Elaboration (address the largest risks, demonstrate technical feasibility)
Construction (build the software with a working version at each iteration)
Transition (documentation, training, deployment of software).

The Project Management tool of this invention has to be flexible to adapt to a process ethos which may be chosen on a basis of function, industry sector or company history. The software vendors behind our ‘Killer’ application are free to choose from the more traditional waterfall (loosely described as reactive process), iterative and spiral variants etc.

In this example, the software development company designing the ‘Killer’ application decide to adopt the popular Structured Systems Analysis and Design Method (SSADM) methodology. SSADM involves the application of a six stage sequence of analysis, documentation and design tasks concerned with business activity (BSO) modelling, requirements investigation, Data Flow Modelling (DFD), system data structuring and logical data structure modelling (LDS) it is noted that this remains a Analysis->Design-Implement->Build->Test process variation which can be modelled as rows in a traditional Gannt Chart view for sub-projects.

Each sub-project enables sub-project and project milestones to be defined. The sub-project milestones define the core phases that need to be tracked. When the system incorporates the sub-project data into the project Gantt chart the tasks associated with each sub-project milestone will be collated into a single task within the project Gantt chart.

Project core phases and milestones are identified and the alignment of core sub-project phases with project milestones in chronological date order as shown in FIG. 7.

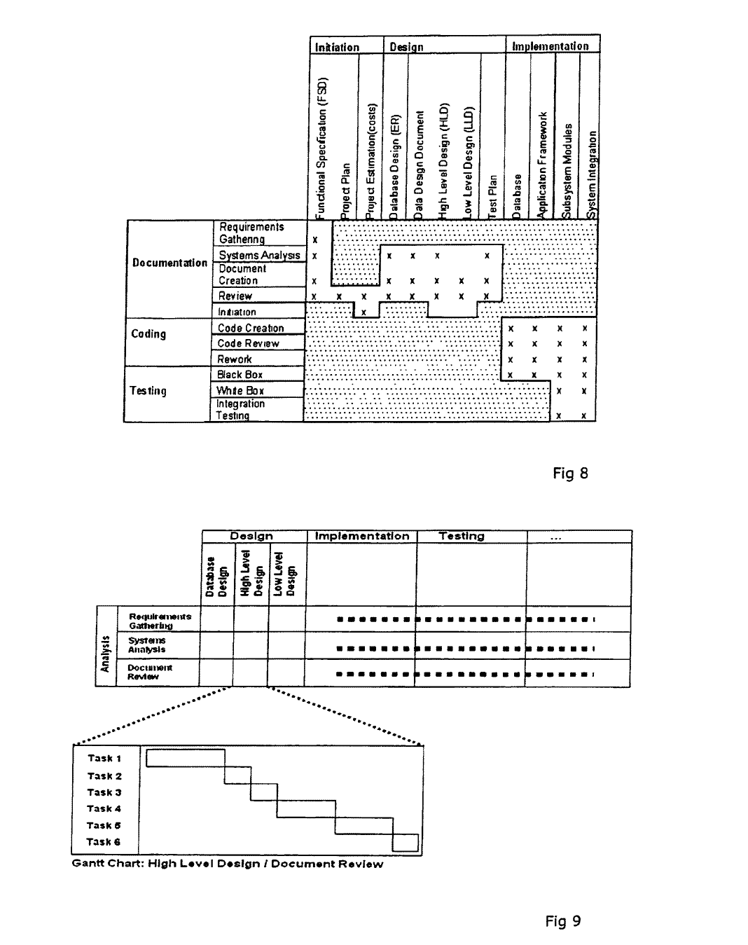

The corresponding Project Map of the various processes and phases will then be as shown in FIG. 8.

The first stage Analysis or feasibility is to investigate the current situation at a high level, which means to consider the potential environment and competitive market for our killer application. The feasibility/analysis stage includes forming a business activity model or vision document.

The initial document/analysis phase can then be sub-divided and applied to the Project map as shown in FIGS. 8 and 9.

The design phase for the development of the ‘Killer’ application project requires the following tasks to be completed:
Requirements gathering/analysis
Context diagram (DFD)
Entity Relationship diagram (ER)
High Level Design
Low Level Design
Review Design

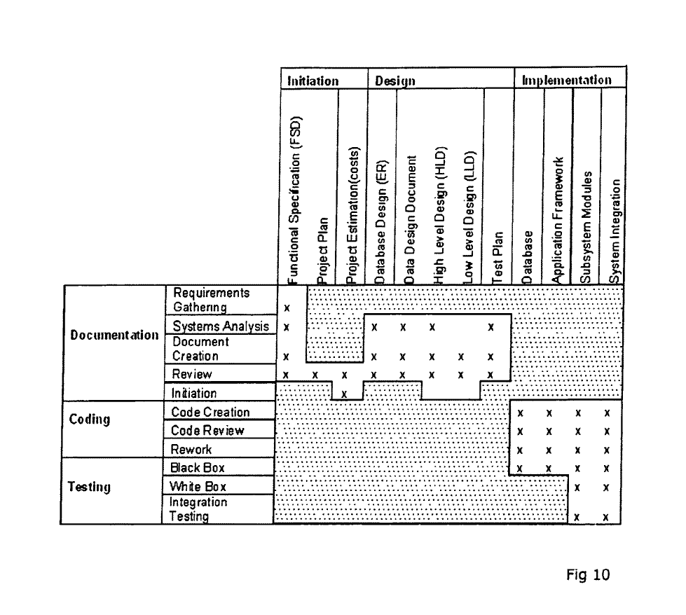

There is an issue that the phases of the software engineering project are chronological, and the Processes that are required are also chronological and therefore the project map will always roughly follow a diagonal line of active cells form top left to bottom right, as shown in FIG. 10,

Typically within a medium to large scale Software development organisation there will be separate functional departments comprising individuals directly and indirectly associated with the software development process. There may be several groups of responsibilities for the development of the application including but not limited to:
Software development and business sector management
Software architects responsible for conceptual design
Software developers responsible for coding implementation
Quality Assurance/Testing also referred to as commercialisation
Build configuration management responsible for overnight builds, script management, cross platform versions.
Installation and licensing engineers
Deployment team—Commercial deployment strategy linking with marketing

The QA testing phases may begin in parallel with the software design (construction) phase with the development of use case scenarios derived from the Functional specification document.

An example of a parallel process phase for the QA team might include but not be restricted to:
QA Plan design (Test Plan document)
Test Suite implementation
Black box (functional requirement) testing
White box (structural) or domain expert testing
Regression test Cases
Automated test cases
Stress/Load and module integration tests.
Test Run analysis
Internal and external domain expert testing collation
Test metric review

Each of these functional teams associated with the software development process will require interaction with a different view of sub-project tasks fitting the context of their job function.

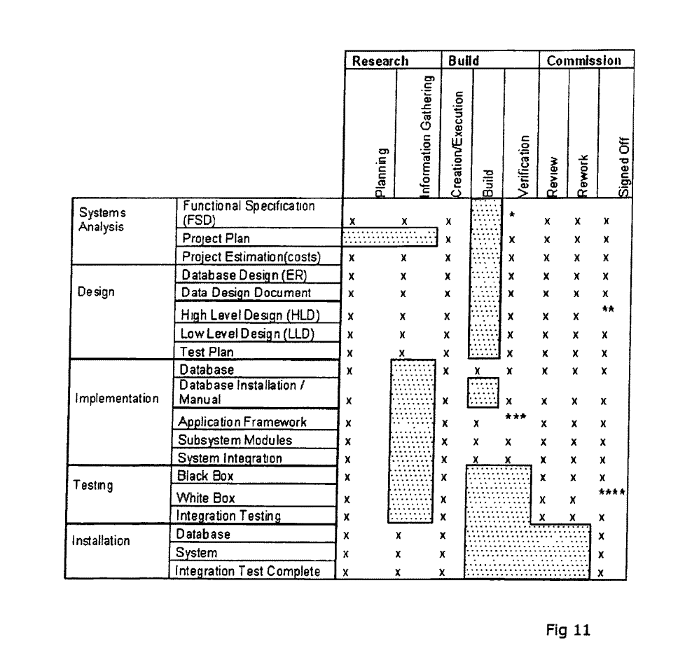

We could re-group our ‘Killer’ application phases to generate a more even spread of processes; although we think of design, implementation and testing as phases, they are also high level project processes. For example: you must ‘do’ a design which can be broken down to HLD, LLD and DD. These Processes have phases, like investigation, creation, review, rework and acceptance, but the important thing is that these phases can be used to describe a code review as easily as an PSD review. Hence you get a grid, and not a diagonal line. This then gives the layout shown in FIG. 11.
Examples:=syntax/spell checking
**=HLD complete
***=semantic checks
****=feature test complete

This appears to resolve the issue of a uniform spread of active cells. However, it has created another issue; the distribution of tasks within each active cell is now heavily weighted (e.g. in the implementation Processes there is a greater emphasis on the creation of subsystem modules than on database planning and there would be a great many more tasks associated with it), Also, the defined sub-phases are very ‘woolly’, which is necessary to fit all Processes into the same phases (e.g. the documentation and implementation share a creation phase). This implies that the Processes' tasks are similar, which they are not. The phases may as well be named ‘Beginning’, ‘Middle’, and ‘End’.

The issues of the uneven distribution of tasks within the cells, and the ‘woolly’ sub-phase definitions only affect the low level Project Map. The (top level) Project Map only shows Processes and Phases (not Sub-Processes and Sub-Phases) and does not suffer from this problem. Therefore, the Project Map will show the project in its entirety, but when selecting to view a particular master cell, only the Project Map for this high level project Process will be displayed. This is like a fractal pattern whereby each master cell is actually another Project Map.

To fit this paradigm precisely, when selecting a Master Cell, only the Sub-Processes and Sub-Phases of the selected Process and phase should be displayed, however there is no benefit in not showing all phases for the selected Process, and would restrict the user for no good reason.

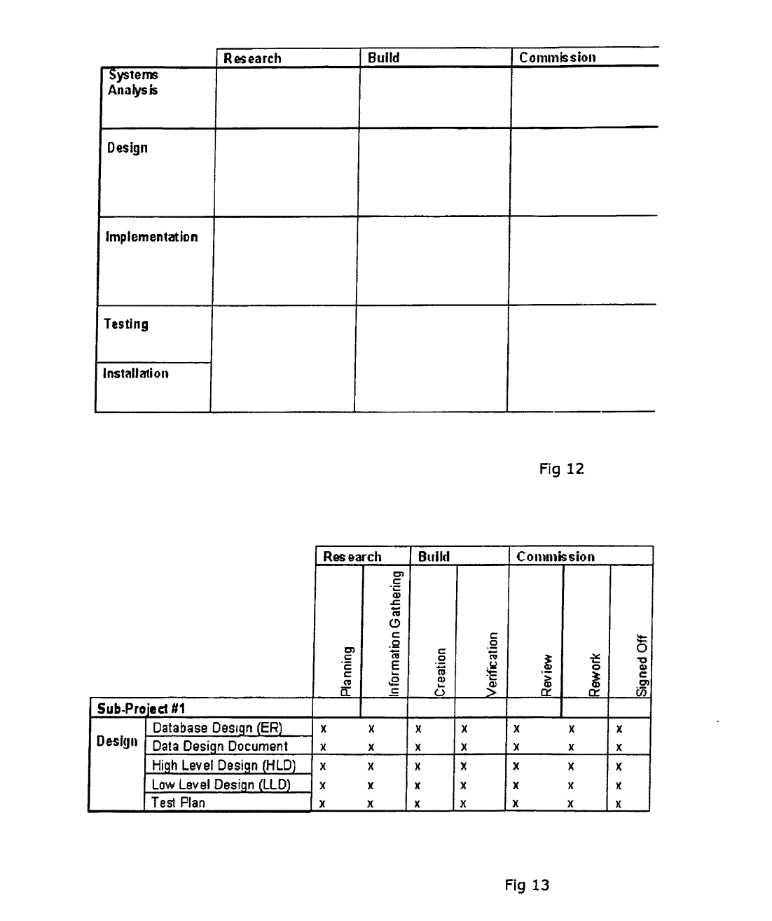

The example at FIG. 12 shows the Project Map for the ‘Killer’ application software engineering project: Each master row (phase) indicates the status of a lower level Project Map. And, by selecting a master cell, this lower level Project Map can be displayed e.g. a Design Master Cell would reveal the Project Map of FIG. 13.

It is important to understand that the process associated with each phase of a project (e.g. systems analysis, design, implementation, etc) varies considerably. Therefore the top level project map can not show sub-process information because it displays several phases simultaneously. The solution, as illustrated in the above figure, is to require the user to select a phase (master row) within the top level project map, thus causing the system to drill down and generate a sub-project map view showing the sub-phases/sub-processes specific to the selected phase.

Adding Processes and Sub-Processes

The Project Map will be initially defined from a template (which is chosen by the user at the beginning of the project). The templates will be constructed by engineers. However, once a template has been selected, it will be possible for a user to alter the Project Map. This will be necessary to add and remove both Processes and Sub-Processes.

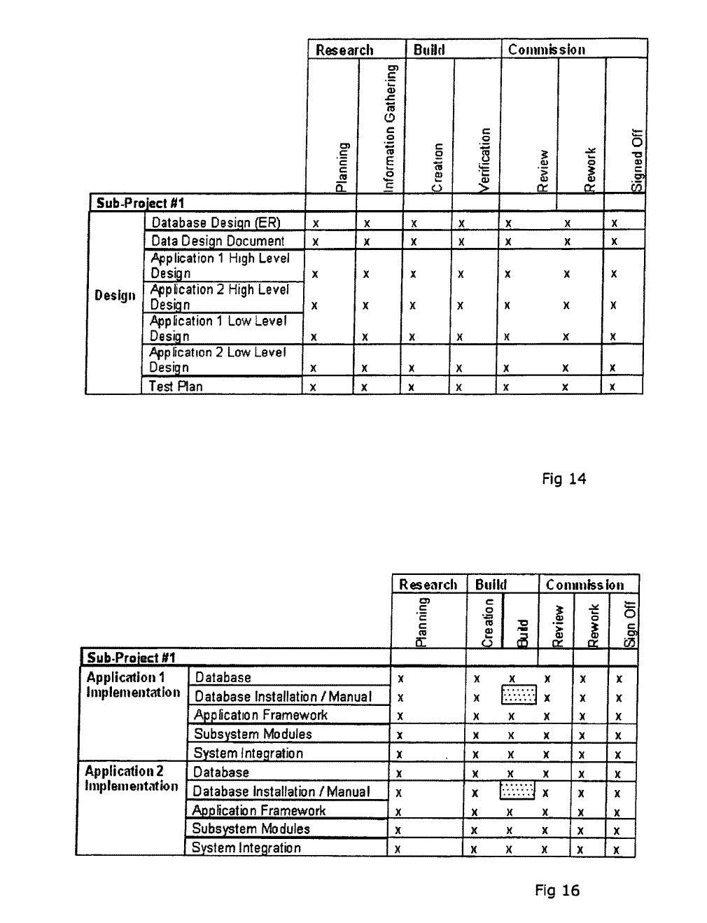

For example; a typical project will have multiple HLD and LLD Sub-Processes as shown in FIG. 14.

This cannot be known at the time of the creation of the template, therefore must be added once the project has begun. The Sub-Processes will be added by selecting from pre-defined types of Sub-Processes associated with the given Process (e.g. DD, HLD, LLD, or TP). The definition of the Sub-Process types will include the associated Sub-Phases. The Sub-Phases will inherit a colour code from its parent Phase (the definition of the Phase will include the specification of its colour code).

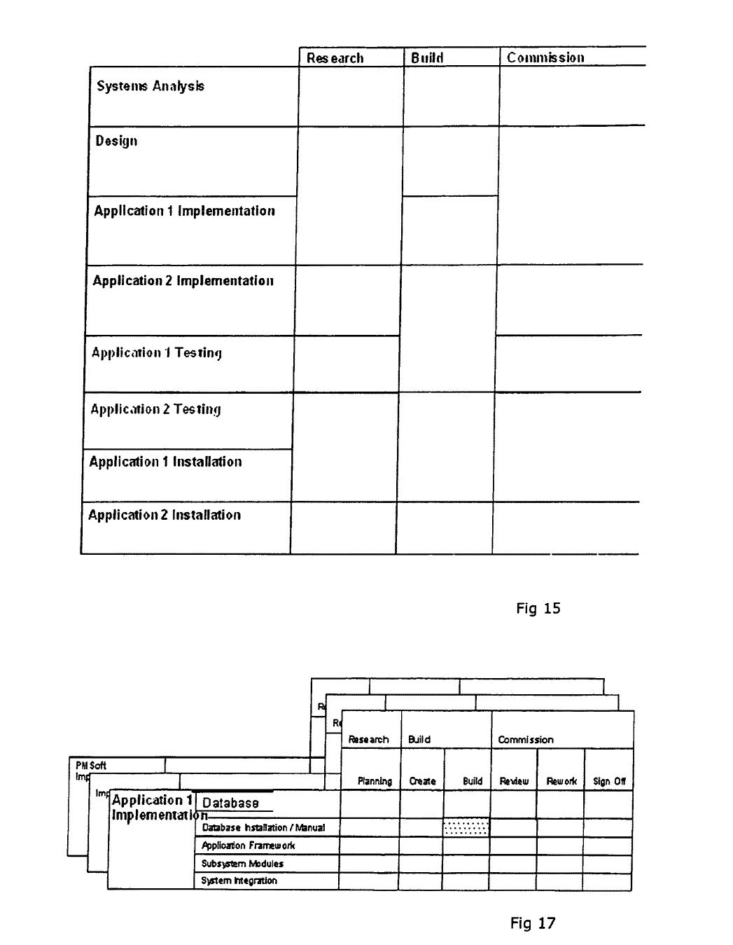

Likewise, the implementation, testing and installation will have multiple Processes as shown in FIG. 15.

Processes will be added by selecting from pre-defined types of Process. The definition of the Process types will include a set of Sub-Processes, and a colour code. This colour code will be inherited by the child Sub-Processes. The Process definitions will also include a position (i.e. in the example above Installation will follow Testing).

When adding a new Process, its position relative to other Processes of the same type must be input from the project manager (i.e. Application 2 Testing will follow Application 1 Testing).

Likewise, the set of Sub-Processes defined for the given Process will have a defined order, but when adding a new Sub-Process the project manager must specify its position (i.e. Application 2 HLD will follow Application 1 HLD).

The order of the Project Map Processes and Sub-Processes should be generally chronological, however the Project Map does not strictly indicate dates or durations, and these Processes may be concurrent. The ordering is only used to display the Project Map. The Project Map will not automate the ordering of these Processes, but will use the order specified in the Project Template, and those input by the project manager.

When a new Process has been added with the same Sub-Phases as an existing Process the two Processes will be displayed on the same lower level Project Map, as illustrated in FIG. 16.

Multiple Sub-Projects

In addition to adding Processes and Sub-Processes to a single Sub-Project, a Project can be split into Multiple Sub-Projects; each of which with its own Processes and Sub-Processes. Each Sub-Project will have its own Sub-Project map, and therefore can be considered as one of a ‘stack’ of Sub-Project Maps shown in FIG. 17.

Sub-Project Scenarios

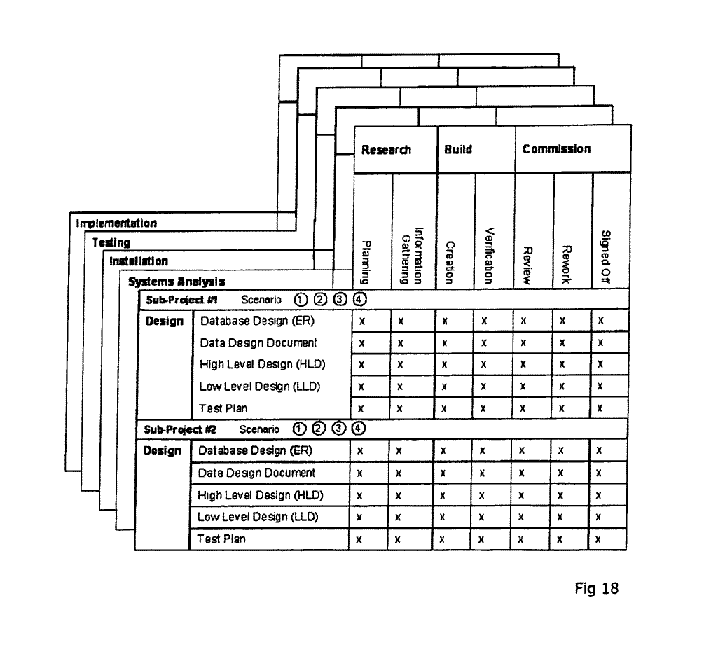

Each Sub-Project may have a number of different scenarios (i.e. different possible ways in which it could be resourced, managed, or organised etc). Only one scenario will be considered to be the active scenario (and will be used to generate the Project Map). However, each of the multiple scenarios could be viewed, or used as the basis for a new scenario, as shown in FIG. 18.

To create a new Scenario an existing Sub-Project Scenario must be cloned. Note when a project is first created there are no alternative scenarios just the definition of the original scenario for that Sub-Project.

Milestones and Traffic Lights

The Project Map invention adds the concept of traffic light indicators into the project plan. Each traffic light will indicate whether it is safe to proceed with the next task.

Milestones are used to indicate progress, and traffic lights are used to indicate quality. The rules determining the colour for each instance of these indicators will vary. However, generally milestones will be green when a project first begins (as a project is not delayed at its instigation), and if delays occur causing a milestone to become in jeopardy, it will change colour to orange and then possibly red. Traffic lights on the other hand will generally be red when a Project starts (as it would not be safe to start any proceeding tasks before quality criteria had been met for earlier tasks), and will turn to orange and green once the specified criteria has been fully met; indicating that it is safe to proceed. The colour of cells will be governed by rules themselves, and will incorporate the status of both Traffic Lights and Milestones. Typically cells will be green when a project begins (as their tasks are not delayed, and work has not begun on them ahead of any quality checks). If their tasks are delayed, or work begins prematurely, they may turn orange, or even red to indicate that there are issues to be addressed.

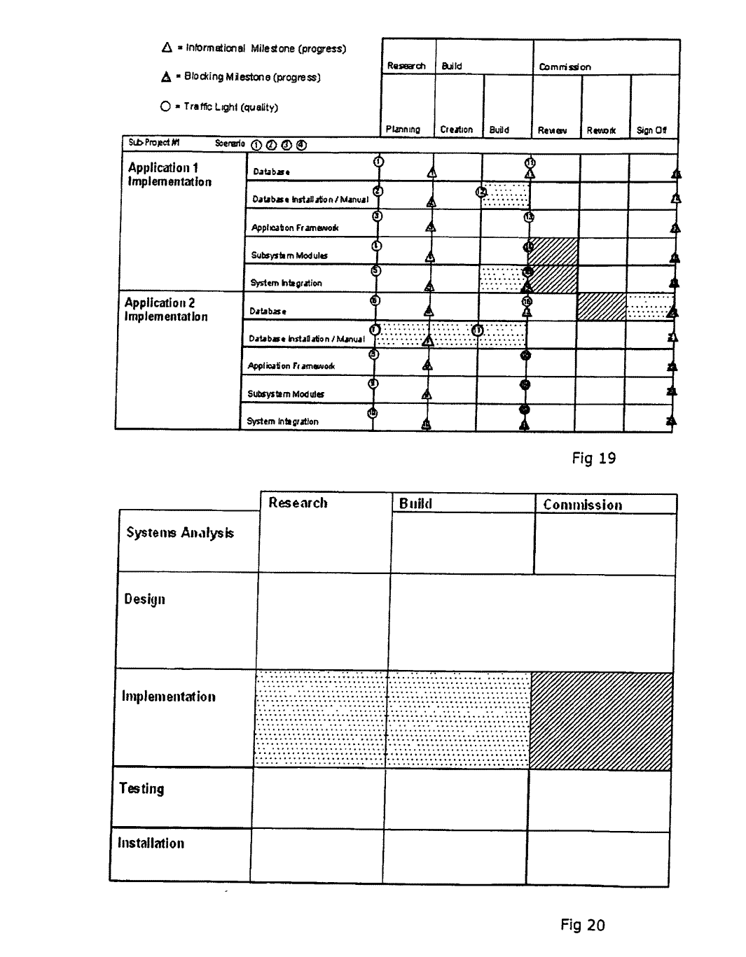

This example Project Map of FIG. 19 shows the status of a software engineering project.

In this example:

Traffic Lights 1-10 are dependant upon milestones in the design phases (e.g. Traffic Light 3 is dependant upon the Application 1 Low Level Design being signed off). In addition, Traffic Lights 2 and 7 are also dependant upon the database implementations being signed off.

The Application 2 database has not been completed. Hence Traffic Light 7 is orange. Work has begun on the Database Manual despite this, hence these cells are orange.

The Application 1 Subsystem Modules have not been built (though they are still on time), hence Traffic Light 14 is red. Despite this, work has begun on reviewing it, hence these cells are red.

The Application 1 System Integration has not been completed, and is delayed, hence the cell is orange. Also, Traffic Light 15, Milestone 15 and subsequent cells are red (because work has begun on the review).

This Project Map example would result in the Project Map of FIG. 20 (when displayed in the worst case view mode): Although this Project Map seems to display Cells within the Master Cells, these are not actually individual cells. Therefore Traffic Lights and Milestones which do not fall on a Master Cell boundary could not be located correctly.

Either no Traffic Lights or Milestones should be shown on the Project Map, or separate ones should be defined (which possibly combine lower level ones). Traffic Lights and Milestones add valuable information to the Project Map, so top level Traffic Lights and Milestones will be defined. These can combine lower level elements, but not all lower level elements will be used to define the top level versions (FIG. 21).

Traffic Lights and Milestones on the Project Map will be considered separately:

The top level Traffic Lights do not follow the same rules as the lower level versions, although they are displayed in the same manor i.e.

Master Cells on the Project Map have colour codes to indicate severity of issues like their lower level Project Map counterparts. However, these colour codes are dictated from the lower level cells' status, and not from the status of tasks.

Traffic Lights on the Project Map have colour codes to indicate if it is safe to continue like their lower level Project Map counterparts. However, these colour codes are dictated from the lower level Traffic Lights, and not from the status of tasks. Also, if a Project Map Traffic Light is red, and work is begun in a subsequent Master Cell, the Master Cell will not be affected by the Traffic Light, but by the status of lower level cells.

All colour codes are determined by rules which are applied to entities, so these differences will just be in the way the rules are applied to entities, and not differences in the entities themselves.

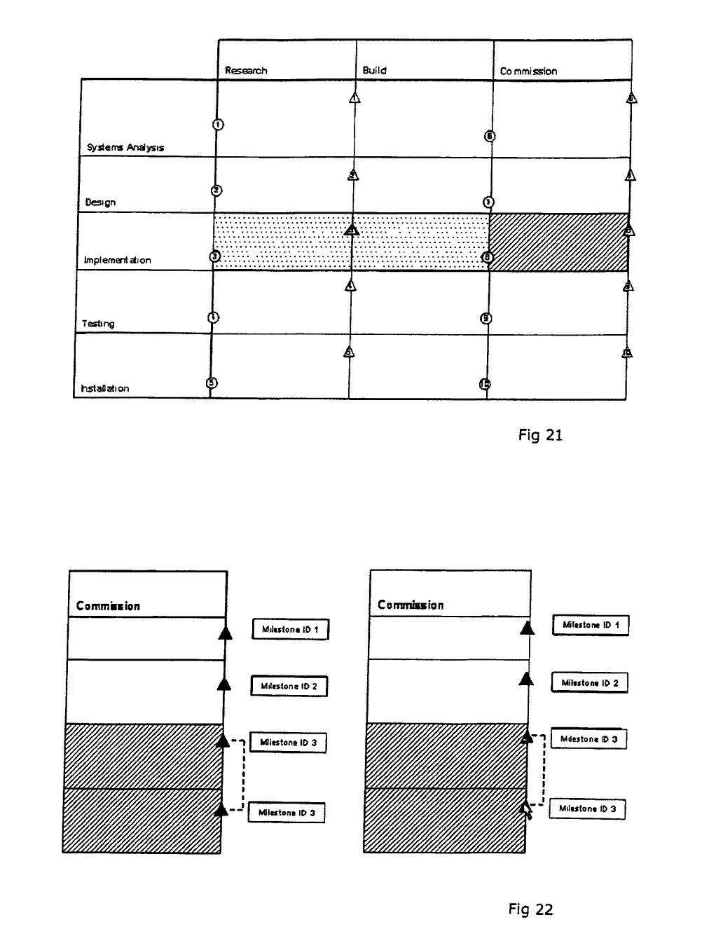

Milestones on the Project Map are different. This is because they are not another instance of a Milestone, but are in fact the same Milestones as those displayed on the Sub-Project Map; a deadline is a deadline regardless of where it is viewed. This causes a number of issues:
1. It may be necessary to provide additional Milestones on the Sub-Project Map which are not displayed on the Project Map. Therefore, when adding a Milestone to a Sub-Project Map, the user must be prompted to determine if the Milestone needs to be displayed elsewhere. Also, the user must have the option to change this setting at a later date.
2. A single Milestone may be applicable to more than one Master Cell (e.g. the implementation of two sub-projects might need to be completed before a single testing Process can begin, and would share a single milestone). Therefore a single Milestone may be displayed in two positions. The Milestone indicators need to be linked visually as shown in FIG. 22 in respect of Milestone ID3. Additionally, each instance of a Milestone will have a unique identifier (i.e. a name or alpha numeric symbol) which can be displayed on the Project Map to identify which Milestones are linked. This will be an option for the user; allowing them to toggle the Milestone tags on or off.
3. When defining milestones, there needs to be a mechanism to align them on each view (Le. if a Milestone is added to the Project Map, where should if be displayed on each Sub-Project map?). This will depend upon how the Milestone is initially defined: if it is defined on the Project Map then it could be logically placed in a corresponding Gantt chart after the last task within the Master Cell, likewise it could be added after the cell on the Sub-Project Map which contains this task. However, there may by times when two tasks finish concurrently and do not reside in the same cell. Also, if a Milestone is automatically placed in one cell (as its task is the last in the Master Cell), what would happen if the tasks changed; would the Milestone automatically move. This is not an acceptable solution as the rules in subsequent Cells would be affected. Therefore the Milestone must be manually placed by the project manager (who may elect to place it on two Cells which are linked as described above). The Milestone will need to be positioned on each Sub-Project map that it is applicable to, and in some cases may appear more than once. Although this will be a manual process, a default position will be automated, which must be approved or changed.
4. Creating Milestones on a corresponding Gantt chart view could lead to problems because it would be possible for users to add a Milestone after any task, including tasks which do not end at a Cell boundary. The Milestone placement on a Gantt chart should then be restricted such that this did not occur. However, it is not clear on the Gantt chart view which Cells this is applicable to and so would lead to confusion. It is better to restrict the Milestone placement to the Project Map views.

If you make the Processes more general so that they can be grouped together (e.g. having a single ‘review’ Process for the FSD and HLD and code) this would stop the tendency for a diagonal line. However, there would then be no real correlation between the tasks, and the rows in the project plan wouldn't really indicate anything. In this case the traffic lights would be meaningless (e.g. it would imply that the code inspection review Process is dependant by the FSD review Process). This is not an acceptable alternative, so the Processes must be specific.

Identification of the completion of individual tasks within a cell may be a combination of quantitative and qualitative analysis metrics. An example would be a beta testing phase for a software sub-project e.g. this may be deemed complete when a criteria such as number of critical defects found per man hours testing time falls below an agreed level and this would be factored alongside a more qualitative judgement such as the potential for failure through any likely user platform conditions outside of the controlled testing environment.

A manager may have to make a qualitative judgement of status e.g. based on the historical accuracy of estimates provided by his manpower. In the absence of appropriate tools to form a reliable quantitative risk assessment a qualitative judgement is often made through a process of inquiry. Look at each cell, one at a time and determine the combined status of the associated tasks contained within it.

Are you on track to making it happen? What are the questions and answers that have been raised? Have they been resolved? Does it look likely that you will resolve all critical issues/questions by any identified deadline? If the answer is yes, the status of that cell is green.

If you have been successful in completing some tasks but cannot honestly predict the outcome of resolution of others classify this cell as orange. You can still make this task green but you just need to give it more attention than you have given it to date.

If there are major problems with a cell then the status will be red, the cell has associated tasks and issues where project or sub-project progress or predicted outcome is limited or likely to fail. Perhaps there was more involved in accomplishing this cell tasks than you had planned on. Or, perhaps the goal was too difficult or you just lost track of it. This cell is in danger of not being completed.

### Example 2

### Building Construction Project

The following example is a simplistic view of a dwelling construction here we see the process distribution within the project map has a more uniform spread this is because:

The reason this seems to work for the construction example above is two fold:
1. Construction projects have very similar high level Processes (foundations, services, floor slabs, walls etc.) even for projects as diverse as schools, dwellings or factories etc.
2. Each of the Processes in the project have very real similarities in their phases, i.e. setting out the services, is almost identical to setting out the footings or the walls, and preparing shuttering for walls is the same as for columns or floors,

On closer examination, the issues for the software engineering project would also exist for the construction project if a higher level view was taken, and the construction design phases were also included within the project. In fact, this is one of the fundamental reasons for the creation of the Project management tool invention; to provide a common tool for all phases of engineering projects.

TABLE 2
Example: Project Map Processes for Construction Project

| Process | Process Phase |
|---|---|
| Footings | Order concrete |
| | Book labourers |
| | Order mechanical digger |
| | Mark Out |
| | Dig Trenches |
| | Concrete |
| Drainage | Order pipes |
| | Book labourers |
| | Order mechanical digger |
| | Mark Out |
| | Dig Trenches |
| | Lay pipes |
| | Backfill |
| Services | Order concrete |
| | Book labourers |
| | Order mechanical digger |
| | Mark Out |
| | Dig Trenches |
| | Lay pipes |
| | Backfill |
| External walls | Order Bricks & Mortar |
| | Book Bricklayers |
| | Book Scaffolding |
| | Mark Out |
| | Build Walls |
| Floor | Order concrete |
| | Book Labourers & Carpenters |
| | Book labourers |
| | Mark Out |
| | Formwork |
| | Lay Floor |
| | Strike Formwork |
| Internal Walls | Order Timber and Plaster |
| | Book Carpenters |
| | Mark Out |
| | Construct Walls |
| Roof | Order Timber and Tiles |
| | Book Roofers |
| | Book Scaffolding |
| | Mark out joist |
| | Construct Roof |
| First Fix | Order Doors and Windows |
| | Book Carpenters |
| | Fit doors and windows |
| Second Fix | Order Plugs, Wires, Taps, and Pipes |
| | Book Plumbers and Electricians |
| | Mark out fittings |
| | Fix Wiring and Plumbing |
| Infrastructure | Order Kerbs, Sub-base, Tarmac and Topsoil |
| | Order mechanical digger |
| | Book labourers |
| | Mark out roads and paths |
| | Dig out roadways |
| | Build roads and paths |
| | Fit manhole covers |

The project phases for this construction project could be: Ground Works, Services, Ground Floor Construction, Topping off, and Internal Fix. However, these correlate very closely with the Processes, and therefore the Project Map will have a tendency to populate cells in a diagonal line from the top left to the bottom right corner (because chronologically the first Processes will occur in the first phase of the project).

Another approach is to use process phases rather than project phases. This gives the following:

TABLE 3
Example: Project Map Phases for Construction Project

| Process | Process Phase | Phase |
|---|---|---|
| Footings | Order concrete | Materials |
| | Book labourers | H. Resources |
| | Order mechanical digger | Plant |
| | Mark Out | Setting Out |
| | Dig Trenches | Preparation |
| | Concrete | Construction |
| Drainage | Order pipes | Materials |
| | Book labourers | H. Resources |
| | Order mechanical digger | Plant |
| | Mark Out | Setting Out |
| | Dig Trenches | Preparation |
| | Lay pipes | Construction |
| | Backfill | Finishing |
| Services | Order concrete | Materials |
| | Book labourers | H. Resources |
| | Order mechanical digger | Plant |
| | Mark Out | Setting Out |
| | Dig Trenches | Preparation |
| | Lay pipes | Construction |
| | Backfill | Finishing |
| External walls | Order Bricks & Mortar | Materials |
| | Book Bricklayers | H. Resources |
| | Book Scaffolding | Plant |
| | Mark Out | Setting Out |
| | Build Walls | Construction |
| Floor | Order concrete | Materials |
| | Book Labourers & Carpenters | H. Resources |
| | Book labourers | Plant |
| | Mark Out | Setting Out |
| | Formwork | Preparation |
| | Lay Floor | Construction |
| | Strike Formwork | Finishing |
| Internal Walls | Order Timber and Plaster | Materials |
| | Book Carpenters | H. Resources |
| | Mark Out | Setting Out |
| | Construct Walls | Construction |
| Roof | Order Timber and Tiles | Materials |
| | Book Roofers | H. Resources |
| | Book Scaffolding | Plant |
| | Mark out joist | Setting Out |
| | Construct Roof | Construction |
| First Fix | Order Doors and Windows | Materials |
| | Book Carpenters | H. Resources |
| | Fit doors and windows | Construction |
| Second Fix | Order Plugs, Wires, Taps, and | Materials |
| | Pipes | H. Resources |
| | Book Plumbers & Electricians | Setting Out |
| | Mark out fittings | Construction |
| | Fix Wiring and Plumbing | |
| Infrastructure | Order Kerbs, Sub-base, | Materials |
| | Tarmac and Topsoil | H. Resources |
| | Order mechanical digger | Plant |
| | Book labourers | Setting Out |
| | Mark out roads and paths | Preparation |
| | Dig out roadways | Construction |
| | Build roads and paths | Finishing |
| | Fit manhole covers | |

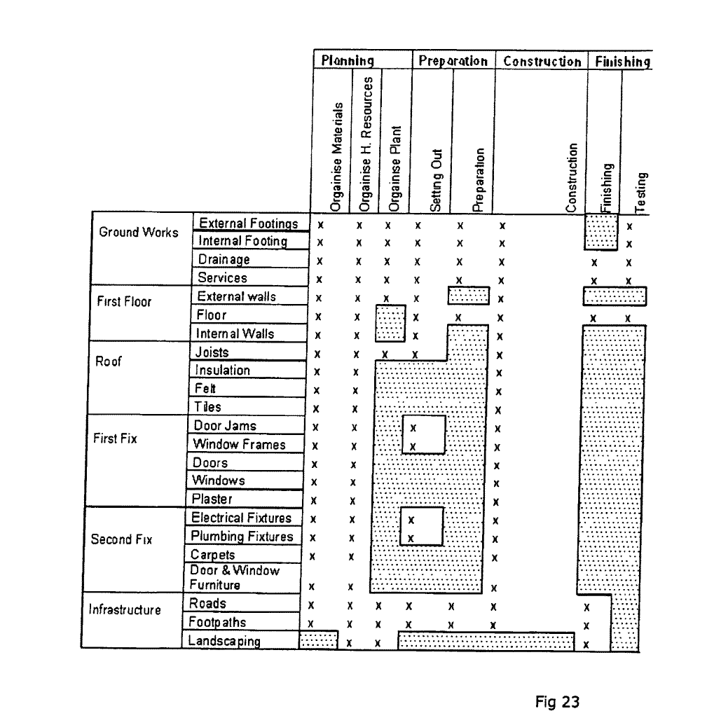

Because all of the Processes follow very similar phases, there is now a more even distribution of active cells in the Project Map, shown in FIG. 23.

Note: Both phases and Processes are chronological, but because the phases are Process phases, not project phases, the plan shows each Process concurrently, and you have a grid, not a diagonal line (as per the Software Engineering example).Although the present invention has been described with reference to preferred embodiments, workers skilled in the art will recognize that changes may be made in form and detail without departing from the spirit and scope of the invention.

What is claimed is:

1. A project management system comprising
a means for storing each of;
a plurality of process definitions,
a plurality of phase definitions,
a plurality of task definitions,
an association between each task definition and a selected process definition and a selected phase definition, and
task status information associated with each task, and
a display means for displaying a two-dimensional grid arrangement in which a first dimension is subdivided according to process definitions and a second dimension is subdivided according to phase definitions, thereby to define a plurality of cells at the intersection of the two dimensions, a plurality of the cells thus defined therefore representing tasks, in respect of which task status information is displayed.

2. The project management system according to claim 2 further comprising means for storing user identities and user rights associated with the user identities, the display means being adapted to limit the display according to the user rights.

3. The project management system according to claim 3 in which the display means limits display of information by withholding information relating to processes and/or phases not defined in the user rights.

4. The project management system according to claim 3 in which the display means limits display of information by aggregating a plurality of cells and displaying a composite task status.

5. The project management system according to claim 1 in which the project is the design of an engineering item.

6. The project management system according to claim 1 in which phase definitions and process definitions are grouped into phase classes and process classes respectively.

7. The project management system according to claim 1 in which the display means is further able to display a two-dimensional grid arrangement in which a first dimension is subdivided according to process classes and a second dimension is subdivided according to phase classes, thereby to define a plurality of cell groups at the intersection of the two dimensions, a plurality of the cell groups thus defined therefore representing a plurality of tasks, in respect of which a composite task status information is displayed,

8. The project management system according to claim 1 in which the display means shows at least one status indicator associated with a cell, the status indicator showing one of a plurality of states, a subset of which indicate that passage to a subsequent phase is acceptable.

9. The project management system according to claim 8 in which the display means shows a status indicator which is an aggregation of task status information and status indicators.

10. The computer system programmed to implement a project management system according to claim 2.

11. The software module arranged when loaded onto a computer system, to implement on that computer system a project management system according to claim 2.

12. A project management summary view comprising a two-dimensional grid arrangement in which a first dimension is subdivided according to processes and a second dimension is subdivided according to phases of work, thereby to define a plurality of cells at the intersection of the two dimensions, a plurality of the cells representing tasks in respect of which task status information is displayed.
